(19) United States
(12) Patent Application Publication
(10) Pub. No.: US 2023/0322336 A1
(43) Pub. Date: Oct. 12, 2023

(54) DEVICE FOR HOLDING AT LEAST ONE COMPONENT ON A LOADING AND/OR OFFLOADING COLUMN OF A TANK OF A SHIP INTENDED TO CONTAIN A LIQUEFIED GAS

(71) Applicant: GAZTRANSPORT ET TECHNIGAZ, Saint-Rémy-Lès-Chevreuse (FR)

(72) Inventor: Florian Bardin, Saint-Rémy-Lès-Chevreuse (FR)

(73) Assignee: GAZTRANSPORT ET TECHNIGAZ, Saint-Rémy-Lès-Chevreuse (FR)

(21) Appl. No.: 18/190,307

(22) Filed: Mar. 27, 2023

(30) Foreign Application Priority Data
Mar. 31, 2022 (FR) 2202915

(51) Int. Cl. F16L 3/10; B63B 27/25

(52) U.S. Cl. CPC B63B 27/25; F16L 3/1091

(57) ABSTRACT

The invention relates to a holding device (9) for holding at least one component on a loading and/or offloading column (5) of a tank (2) of a ship (1) intended to contain a liquefied gas, the holding device (9) comprising at least one ring (91), through which passes the component, and at least one arm (92) which comprises at least one first segment (921, 924) bearing the ring (91) and one second segment (922, 925) bearing a fixing interface (923) for fixing the holding device (9) onto the loading and/or offloading column (5), the first segment (921, 924) and the second segment (922, 925) being configured to be displaced with respect to one another in at least two directions lying in a same plane (100, 400).

### TECHNICAL FIELD

The invention relates to the field of the storage and/or transportation of a cargo of liquefied gas, such as liquefied natural gas, ethane, ammonia or even liquefied petroleum gas.

It relates more particularly to a loading and/or offloading assembly comprising a loading and/or offloading column for a sealed and thermally insulated tank of a ship intended to contain this liquefied gas.

### TECHNOLOGICAL BACKGROUND

Liquefied natural gas, commonly known by the acronym “LNG”, is a major source of energy, composed of approximately 95% methane. More particularly, LNG is stored in the liquid state in a thermally insulated tank at a temperature close to -160° C., the LNG then occupying 1/600 of the volume which it would occupy in the gaseous state, thus making it possible to facilitate the transportation from a first site to a second site.

LNG can thus be transported from one site to the other by sea using ships called methane tankers, and it is then stored in sealed and thermally insulated tanks of the methane tanker.

LNG can also be used as fuel for a ship, such as a goods transport ship, such as a container ship. For ecological and economic reasons, the use of LNG as fuel offers an advantage over conventional fuels, notably derived from oil.

Conventionally, the LNG storage tank comprises a loading and/or offloading column suspended from a cover that makes it possible to close the tank. The loading and/or offloading column of the tank can comprise a structure of tripod type, that is to say comprising three vertical masts linked to one another by crossmembers forming a lattice structure.

The loading and/or offloading column can comprise a plurality of pumps intended for various uses, such as the offloading and/or loading of LNG from or to the tank. In a certain type of configuration, it is known practice to separate the drive motor a. and the suction element of the pump, notably in order to facilitate maintenance operations and/or interventions in case of malfunctioning of the drive motor.

In such a case, the drive motor can be disposed outside of the storage tank, for example on the cover, while the suction element remains immersed in this same tank, such a configuration being included under the term “deep well pump”. The drive motor and the suction element of a same pump are thus arranged at opposite positions of the tank and are separated by a distance substantially equal to its height, preferably between approximately 10 and 30 metres.

The drive motor is mechanically linked to the suction element via a driveshaft housed in a tube of the pump. The rotational movement of the drive motor is thus transmitted to the suction element and the tube channels the liquefied gas so as to drive its extraction out of the tank.

It is essential to ensure securing of the various components of the pumps on the loading and/or offloading column. To this end, the column is equipped with a plurality of supports ensuring the fixing of the various components of the pumps onto the column. The installation of such supports can nevertheless prove lengthy and complex, notably because it requires a precise alignment of the components of the different pumps on the column, and this results in a significant operating cost overhead, notably through the downtime of the ship.

The present invention falls within this context and aims to facilitate the operations of mounting and/or dismounting of the offloading and/or loading column and of the components fixed thereon.

### SUMMARY

The present invention proposes a holding device for holding at least one component on a loading and/or offloading column of a tank of a ship intended to contain a liquefied gas, the holding device comprising at least one ring, through which passes the component, and at least one arm, characterized in that the arm comprises at least one first segment bearing the ring and one second segment bearing a fixing interface for fixing the holding device onto the loading and/or offloading column, and in that the first segment and the second segment are configured to be displaced with respect to one another in at least two directions lying in a same plane.

Preferably, the component is an element distinct from the loading and/or offloading column and does not therefore belong to the loading and/or offloading column.

Through the structure of the holding device, which allows the adjustment of the position of the first segment, bearing the ring and therefore the component, with respect to the second segment, which is secured to the column, the use of said holding device contributes to simplifying the installation of the offloading and/or loading column in the tank and of the components which are attached to it.

According to a feature of the present invention, said plane is parallel to the first segment and/or to the second segment of the arm. Alternatively, said plane can extend transversely to the first segment and/or to the second segment.

The arm comprises the first segment, the second segment and the fixing interface. The first segment and the second segment consist of flat parts, for example made of sheet steel, with a thickness of at least 5 mm in order to ensure the strength of the arm.

The ring has a cylindrical structure centred on the axis of extension of the holding device, through which passes the component. In other words, the ring is engaged on the component and at least partially encircles it.

The first segment and the second segment of the holding device are initially dissociated from one another, the first segment bearing the ring and the second segment bearing the fixing interface. That way, the first segment and the ring can be installed on the component of a pump while the second segment and the interface are disposed on the column, then the position of the first segment and of the second segment with respect to one another is adjusted before effecting the securing thereof.

Alternatively, the first segment and the second segment can be assembled during a first step, then, during a subsequent step, the component can be fixed to the ring borne by the first segment.

Optionally, the fixing interface can comprise at least one adjustment means for adjusting the position of the holding device on the loading and/or offloading column. The adjustment means can consist of at least one oblong orifice or one circular orifice included in the fixing interface, which is configured to cooperate with the loading and/or offloading column, for example with at least one circular orifice or one oblong orifice of the column.

The holding device according to the invention is thus easily mounted, the dissociable arm and the adjustable positioning of the first segment and of the second segment making it possible to address the precision constraints involved in the mounting of the pumps on the column.

According to a feature of the invention, the ring is centred on an axis of extension of the holding device, the axis of extension extending parallel to the plane in which the first segment and the second segment can be displaced with respect to one another.

According to a feature of the invention, the ring is centred on an axis of extension of the holding device, the axis of extension extending orthogonally to the plane in which the first segment and the second segment can be displaced with respect to one another, and preferably, the axis of extension extends at right angles to said plane.

According to a feature of the invention, the ring is composed of at least one first half-shell and one second half-shell, the first half-shell and/or the second half-shell being borne by the first segment.

Each half-shell, for example, takes the form of a half-cylinder of complementary form which, once assembled, together reconstitute the ring. Advantageously, the first half-shell and the second half-shell can have substantially identical structures, thus reducing manufacturing costs of the holding device.

Preferably, an inner wall of the ring comprises at least one skid allowing the displacement of the component with respect to the ring of the holding device.

According to a feature of the invention, the holding device comprises at least one reinforcement secured to the first segment and to the ring and/or to the second segment and to the fixing interface.

The reinforcement can, for example, take the form of a bracket which extends at right angles to the first segment and/or to the second segment. Notably, the holding device can comprise a plurality of reinforcements, for example regularly disposed between an outer wall of one of the half-shells of the ring and the first segment so as to consolidate the fixing thereof.

In fact, since the cargo of liquefied gas is subject to a “sloshing” phenomenon when being transported, not-inconsiderable mechanical strains are exerted on the loading and/or offloading column and the pump or pumps that it includes. Such strains can result in an alteration of the position of the components of the pump with respect to the column, but also in a deformation of the components of the pump. It is therefore critically important for the holding device to have a structure that is strong enough to withstand such strains.

The aim of such holding devices is to ensure the optimal holding of the components on the column, for example a suction element, that are more likely to undergo such strains through their arrangement around the bottom wall of the tank.

According to an embodiment of the invention, the first segment and the second segment each respectively comprise two wings extending away from one another, the separation between the wings of the first segment being different from the separation between the wings of the second segment, so as to allow an overlap between each wing of the first segment with a wing of the second segment situated facing it. The use of several wings allows the number of anchoring points on the column to be multiplied, favouring its resistance to the mechanical strains.

According to a feature of the invention, the separation between the wings of the first segment is greater than the separation between the wings of the second segment.

According to a feature of the invention, the wings of the first and second segments each comprise inner faces disposed in such a way that an inner face of one wing of a segment is disposed facing an inner face of the other wing of said segment and outer faces opposite said inner faces, each inner face of a wing of the first segment being preferably disposed facing an outer face of a wing of the second segment.

According to a feature of the invention, at least one link assembly is disposed between the inner face of a wing of one segment and the outer face of a wing of the other segment disposed facing it.

The presence of the link assembly multiplies the possibilities of positioning of the first segment and of the second segment with respect to one another.

According to a feature of the invention, the first segment and the second segment are secured to one another by assembly means, said assembly means being preferably removable.

According to a feature of the invention, the assembly means comprise at least one fixing member for fixing the first segment onto the second segment, the first segment and/or the second segment comprising at least one oblong hole which receives the fixing member. As an example, the fixing member can be a screw-nut system.

In the embodiment in which the first segment supports the outer wall of one of the half-shells, the first segment can comprise a cutout of a form complementing the outer wall of this half-shell so as to facilitate the incorporation thereof. In such a configuration, the first segment can comprise a pair of oblong holes, the oblong holes being disposed on either side of the cutout. In particular, at least the oblong hole can extend parallel to one of the two directions of adjustment lying in the plane in which the first segment and the second segment can be displaced with respect to one another.

According to a feature of the invention, the first segment and the second segment each comprise at least one oblong hole at least partially disposed facing one another, the oblong hole of one segment extending mostly in a direction at right angles to a major direction of extension of the oblong hole of the other segment.

The invention relates also to a loading and/or offloading assembly for a tank of a ship intended to contain a liquefied gas comprising a loading and/or offloading column provided with at least one mast intended to extend in the tank, at least one offloading device and at least one holding device as described above holding at least a part of the offloading device on the loading and/or offloading column, the holding device preferably holding at least a part of the offloading device on the mast.

Preferably, the offloading device is a distinct element and does not belong to the loading and/or offloading column.

The loading and/or offloading column is composed of at least one mast which extends over all or part of the height of the tank, that is to say between a top wall and a bottom wall of the tank, the masts being fixed with respect to the tank. Advantageously, the loading and/or offloading column can comprise two or three masts. Additionally, said loading and/or offloading assembly can comprise a cover intended to close an opening of the top wall so as to make the tank sealed and thermally insulating, the cover holding the loading and/or offloading column suspended in the tank and the cover being secured to at least the mast.

More particularly, a plurality of holding devices can ensure the attachment of a same component to the column, in other words, the same component passes through the respective rings of a plurality of holding devices.

According to a feature of the present invention, the offloading device comprises at least one suction element, disposed in the tank, and a drive assembly for driving the suction element, disposed outside of the tank, the suction element and the drive assembly being linked to one another by an offloading duct, the ring of the holding device at least partially encircling the offloading duct.

Preferably, the offloading device also comprises a driveshaft mechanically linking the suction element and the drive assembly in order to transmit a rotational movement of the drive assembly to the suction element. Also, the offloading device comprises a tube which extends at least partly in the tank and which houses the driveshaft.

Preferably, the offloading device is a pump.

The invention also proposes a tank of a ship intended to contain a liquefied gas comprising a loading and/or offloading assembly as described previously.

The invention also proposes a method for mounting an offloading device on a loading and/or offloading column using at least one holding device as previously described, comprising the fixing of the second segment onto the loading and/or offloading column via the fixing interface, said method comprising the following steps:
a first step of fixing of the first segment and the second half-shell borne by the first segment onto the second segment in a first, so-called adjustment position in which the first segment is positioned as close as possible to the loading and/or offloading column;
a second step of final positioning of at least one element of the offloading device in the tank;
a third step of displacement of the first segment and of the second half-shell to a second, so-called final position in which the second half-shell is positioned as close as possible to the element of the offloading device;
a fourth step of assembly and of fixing of the first half-shell onto the second half-shell so as to encircle said element of the offloading device between the first half-shell and the second half-shell.

According to a feature of the present invention, the element of the offloading device is an offloading duct.

The invention also proposes a ship for transporting a cold liquid product, the ship comprising a double-hull and a tank as described previously, disposed in the double-hull.

Alternatively, the invention can relate to an onshore structure comprising at least one tank as previously described.

The invention also proposes a transfer system for a cold liquid product, the system comprising a ship as described previously, insulated pipelines arranged so as to link the tank installed in the double-hull of the ship to a floating or onshore storage installation and a pump for driving a fluid through the insulated pipelines from or to the floating or onshore storage installation to or from the tank of the ship.

The invention also propose a method for loading or offloading a ship as described previously, in which a fluid is conveyed through insulated pipelines from or to a floating or onshore storage installation to or from the tank of the ship.

### BRIEF DESCRIPTION OF THE FIGURES

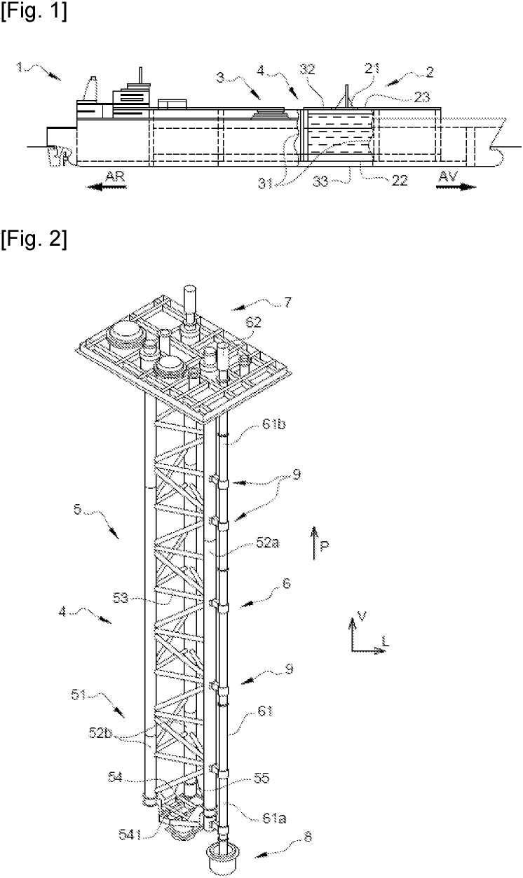

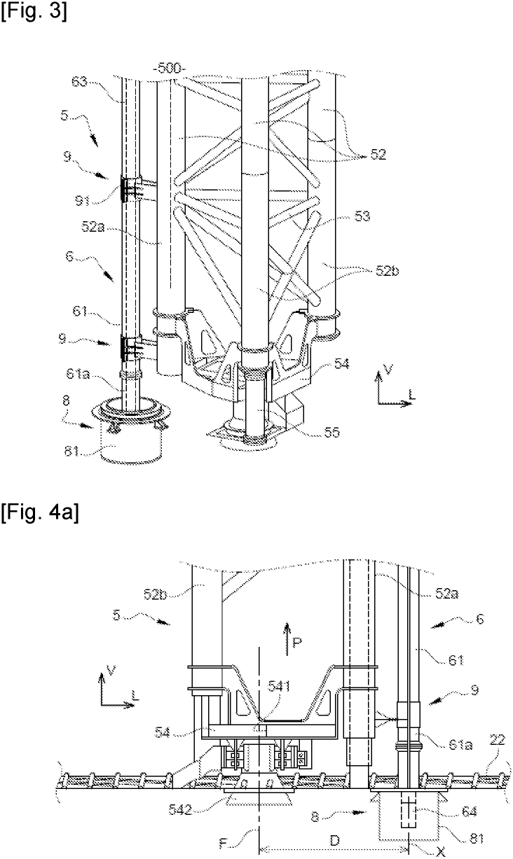

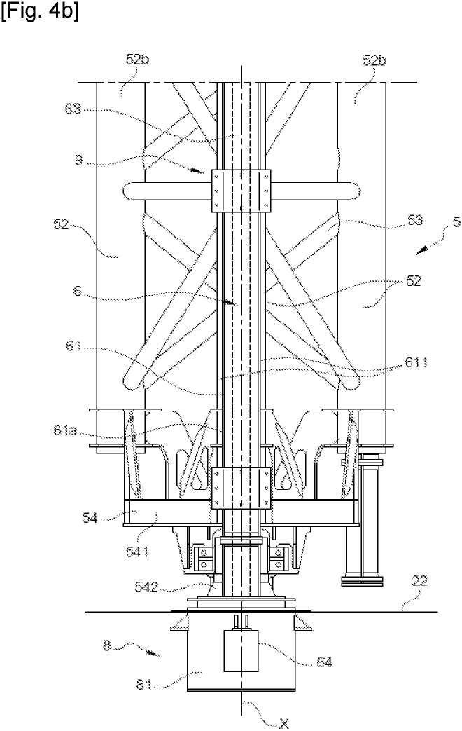

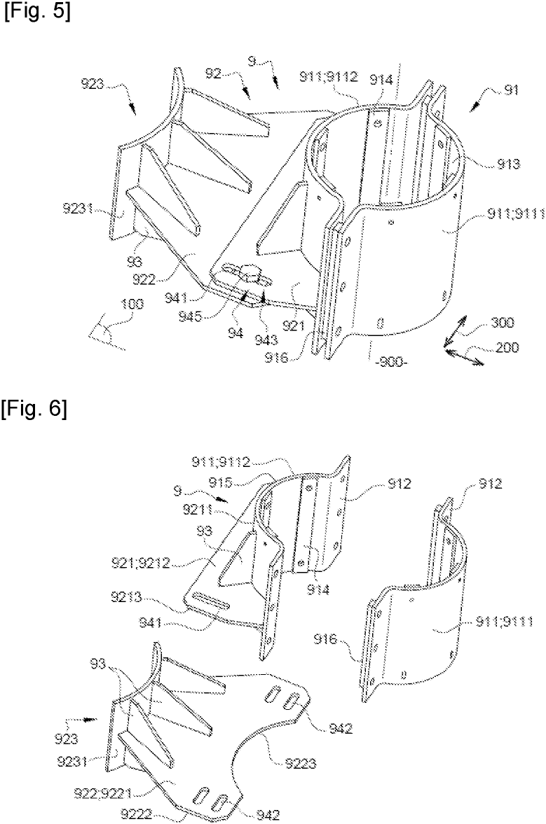

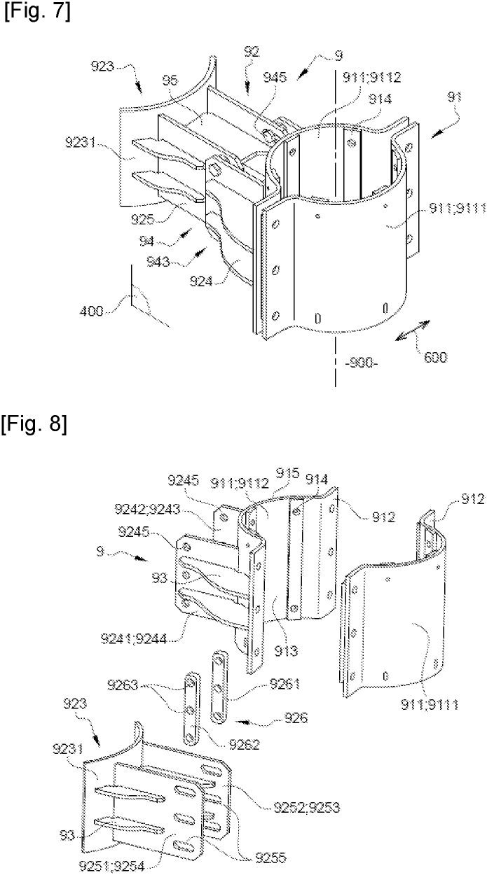

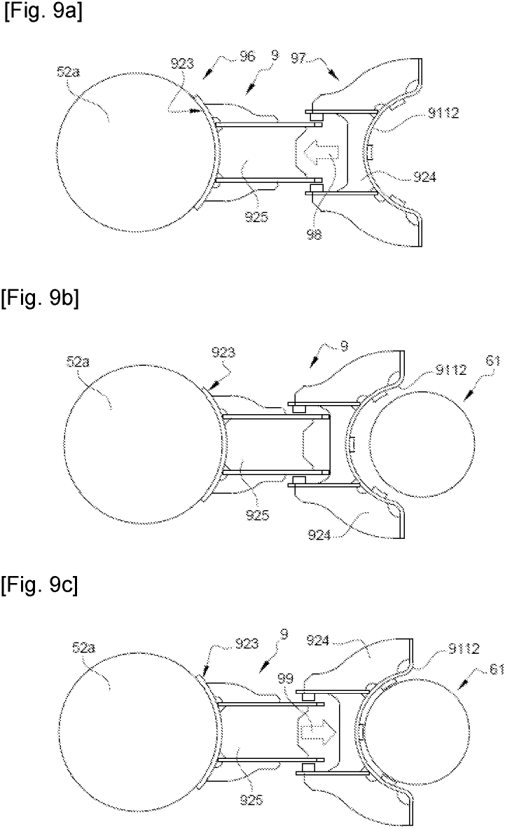

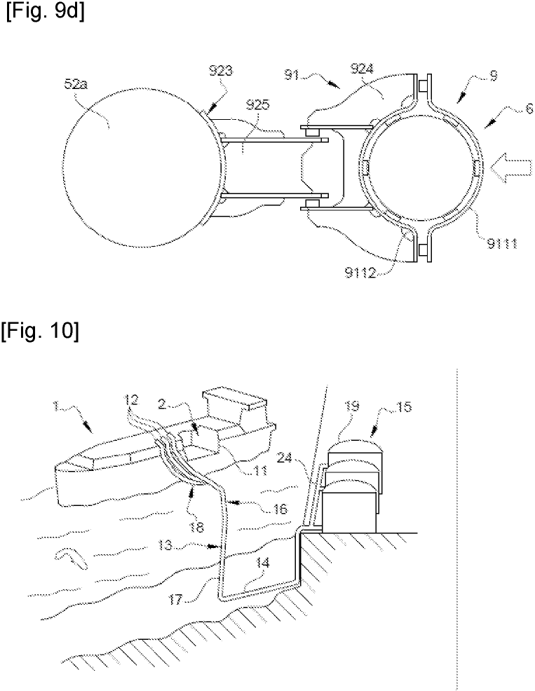

The invention will be better understood, and other aims, details, features and advantages thereof will become more clearly apparent from the following description of several particular embodiments of the invention, given in a purely illustrative and nonlimiting manner, with reference to the attached drawings.

[FIG. 1] FIG. 1 is a schematic view of a ship comprising a liquefied gas storage tank incorporating a loading and/or offloading assembly according to the invention;

[FIG. 2] FIG. 2 is a perspective schematic view of the loading and/or offloading assembly of FIG. 1;

[FIG. 3] FIG. 3 is a perspective schematic view of a base of the loading and/or offloading assembly of FIG. 2;

[FIGS. 4a and 4b] FIGS. 4a and 4b are two close-up side views, from different orientations, of a part of the loading and/or offloading assembly of FIG. 2;

[FIG. 5] FIG. 5 is a perspective view of a holding device according to the invention belonging to the loading and/or offloading assembly of FIG. 2, produced according to a first embodiment;

[FIG. 6] FIG. 6 is an exploded perspective view of the holding device as represented in FIG. 5;

[FIG. 7] FIG. 7 is a perspective view of the holding device according to the invention, produced according to a second embodiment;

[FIG. 8] FIG. 8 is an exploded perspective view of the holding device as represented in FIG. 7;

[FIGS. 9a to 9d] FIGS. 9a to 9d represent different steps of mounting of the holding device performed according to the second embodiment on elements of the loading and/or offloading assembly of FIG. 2;

[FIG. 10] FIG. 10 is a cut-away schematic representation of a ship comprising a liquefied natural gas storage tank and a terminal for loading/offloading this tank.

### DESCRIPTION OF THE EMBODIMENTS

The features, variants and various embodiments of the invention can be associated with one another, according to various combinations, in as much as they are not mutually incompatible or exclusive. It will also notably be possible to devise variants of the invention comprising only a selection of features described hereinbelow in a way that is isolated from the other features described.

FIG. 1 represents a ship 1 for transporting a liquefied gas. The ship comprises at least one tank 2 intended for the storage of gas in the liquid state, particularly liquefied natural gas (“LNG”), liquefied petroleum gas (LPG) or any other liquefied gas, such as ammonia. Preferably, the gas transported is liquid at a cryogenic temperature.

The ship 1 comprises a bearing structure 3 intended to receive the walls of the tank 2. The bearing structure 3 is notably formed by the double-hull of the ship 1. The bearing structure 3 has a generally polyhedral form. The bearing structure 3 comprises front and rear transverse walls 31, called cofferdam walls of the ship, extending transversely to the longitudinal direction of the ship 1. The bearing structure 3 also comprises a top wall 32 and a bottom wall 33 extending in the longitudinal direction of the ship and linking the front and rear transverse walls 31.

Thus, the top 32, bottom 33 and transverse 31 walls form bearing walls of the bearing structure. These bearing walls have a surface area delimiting an internal space in which the tank 2 is housed. The tank 2 comprises a plurality of tank walls, each tank wall is anchored onto a respective bearing wall of the bearing structure 3. Traditionally, the rear transverse wall is the one oriented towards the bridge of the ship, while the front transverse wall is the one oriented towards the bow.

Preferably, the tank 2 is a tank with a membrane having a multilayer structure. The tank comprises, in the thickness-wise direction from the outside to the inside of the tank, a secondary thermally insulating barrier, a secondary sealed membrane resting on the secondary thermally insulating barrier, a primary thermally insulating barrier resting on the secondary sealed membrane and a primary sealed membrane resting on the primary thermally insulating barrier and intended to be in contact with the liquefied gas contained in the tank 2. Thus, in order to keep the gas in the liquid state, the tank is sealed and thermally insulated.

The tank 2 is equipped with a loading and/or offloading assembly 4 according to the invention which makes it possible, depending on the desired mode of use, to extract liquefied gas out of the tank, but also to supply the tank with liquefied gas.

The loading and/or offloading assembly 4 comprises at least one loading and/or offloading column 5, an offloading device 6 and a cover 7 intended to close a storage volume of the tank 2. Hereinafter in the description, the loading and/or offloading column will be called the column for the purposes of simplicity.

More particularly, the tank 2 comprises an aperture 21, formed in the top wall 23 of the tank, intended notably to allow the passage of the column 5 into the chamber of the tank 2, for example when it is being installed. The aperture 21 is configured to cooperate with the cover 7 of the loading and/or offloading assembly 4, which, when the column 5 is installed in the tank, extends parallel to the top wall 23 of the tank 2 and closes the aperture 21 to render the tank sealed and thermally insulated.

The cover 7 consists of a flat plate made secure to the top wall 23 of the tank by welding and/or by means of fixing members, such as a screw/nut system. The cover 7 is composed of a set of metal parts which give it mechanical strength and can also comprise a thermal insulation. The cover 7 is configured to keep the column 5 suspended in the tank.

As can be seen in FIG. 2, the cover 7 is at least partly passed through by the column 5 and by the offloading device 6.

The column 5 comprises a structure 51 which extends in a main direction of elongation P in the vertical direction V, comprising at least three masts 52. More specifically, the structure 51 of the column 5 also comprises a lattice structure 53 intended to link together the various masts 52 of the column 5 in order to rigidify the latter. The lattice structure 53 is composed of a plurality of intersecting cylindrical small beams extending between at least two masts 52 of the column, over all or part of its height.

Preferably, each of the three masts 52 passes through the cover 7 of the tank. A front mast 52a and two rear masts 52b are thus defined, defined in a direction of advance A of the ship, visible in FIG. 1, in normal navigation conditions, the front mast 52a being the foremost mast of the structure 51 in the tank 2. Thus, the rear masts 52b are situated in proximity to the rear transverse wall of the bearing structure 3, whereas the front mast 52a is, for its part, oriented towards the front transverse wall. In other words, in the longitudinal direction of the ship, the rear masts 52b are interposed between the rear transverse wall of the bearing structure 3 and the front mast 52a.

As can be seen in FIG. 2, the structure 51 has, in projection, a substantially triangular form, of which each of the masts 52 forms one of the vertices of this triangle. Thus, the triangle formed by the structure 51 comprises at least one base defined by a straight line running through the two rear masts 52b and a vertex defined by the front mast 52a, otherwise called front vertex.

Thus, the column 5 comprises a plurality of masts 52 extending from the cover 7 to the bottom wall 22 of the tank 2, in line with the aperture 21.

Each mast 52 of the column 5 consists of a hollow rod, of circular section, and that can, for example, be made of stainless steel. A mast 52 is composed of a plurality of cylindrical segments welded to one another. A first end of the mast extends around the top wall 23 of the tank, a second end of the mast, opposite the first end, extends around the bottom wall 22 of the tank. Thus, the masts 52 each define a duct that can, for example, contain at least one pump element.

The masts 52 of the column 5 are, around their respective second end, held secure by means of a base reinforcement 54 which passes at least partly through the bottom wall 22 of the tank 2. More specifically, the base reinforcement 54 comprises at least one platform 541 secured to each of the masts 52 of the structure 51 of the column 5 and a foot 542 which extends from the platform 541 and is made secure to the bottom wall 33 of the bearing structure 3 by passing through the bottom wall 22 of the tank 2.

In the example illustrated in FIGS. 2 and 3, one of the rear masts 52b of the column 5 is equipped with an offloading pump 55 housed at least partly in the hollow rod of the mast 52b. The other rear mast 52b and the front mast 52a are structural masts supporting the column and the offloading device 6.

These structural masts can also serve to support a liquefied gas loading duct, not represented, the function of which is to allow the tank to be filled with liquefied gas, but also a supply pump intended to supply liquefied gas to an engine, not represented, of the ship.

As can be seen in FIG. 2, the offloading device 6, distinct from the offloading pump 55 housed in one of the rear masts 52b of the column 5, comprises an offloading duct 61, a suction element 64 disposed at a first end 61a of the offloading duct 61, and a drive assembly 62 disposed at a second end 61b of the offloading duct 61. The cover 7 is disposed between the suction element 64, visible in FIGS. 4a and 4b, and the drive assembly 62. More specifically, the suction element 64 is disposed in the storage volume of the tank 2 whereas the drive assembly 62 is disposed outside of the storage volume of the tank 2 and is preferably borne by the outer face of the cover 7. At least one driveshaft 63, partly visible in FIGS. 3 and 4b and represented by dotted lines, links the suction element 64 to the drive assembly 62. More specifically, the driveshaft 63 extends in an internal volume of the offloading duct 61 and allows the suction element 64 to be actuated under the effect of the drive element 62 in order to allow liquefied gas to be pumped and extracted out of the tank.

As represented in FIGS. 2 and 3, the offloading duct 61 is a component distinct from the loading and/or offloading column 5. In other words, the offloading duct 61 is a component distinct from the structure 51.

According to a preferential embodiment, the offloading duct 61 is situated in front of the front mast 52a in the longitudinal direction L of the tank 2. Thus, the offloading duct 61 is not included in the triangular form delimited by each of the masts 52. In the example represented, the offloading duct 61 extends parallel to the front mast 52a which supports it. Thus, the offloading duct 61 and the front mast 52a extend in the vertical direction V.

As represented in FIGS. 3 and 4, the offloading device 6 also comprises at least one, and preferably two, rod(s) 611 that are used to control a check valve of said device. The rod 611 is independent of the offloading duct 61 and extends along the latter.

The different elements that constitute the offloading device 6 extend along the main direction of elongation P in the vertical direction V, at right angles to the bottom wall 22 of the tank 2.

The drive assembly 62 can notably be a gear motor assembly comprising a motor and a device for reducing the speed of the suction element 64.

In order to improve the suction of the liquefied gas when offloaded from the tank 2, notably when a maintenance operation is scheduled, the bottom wall 22 of the tank is equipped with a sump 8 that can be seen in FIGS. 2 to 4. The sump 8 corresponds to a volume which extends in the bottom wall 22 of the tank 2 and which is delimited by a sump wall 81, here cylindrical about an axis of revolution X. The sump 8 notably makes it possible to form a reduced volume to facilitate the collection of the liquefied gas by the suction element 64 of the offloading device 6 by concentrating said liquefied gas in this volume which is reduced compared to the storage volume of the tank 2. It is then understood that the suction element 64 of the offloading device 6 extends at least partly into the volume of the sump 8.

As can be seen in FIGS. 4a and 4b, the sump 8 is formed in the bottom wall 22 of the tank 2 such that a centre thereof, here positioned on its axis of revolution X, is at a distance D, at least greater than 2 m, from the centre F of the foot 542 of the base reinforcement 54. It is understood that the distance is taken along a straight line at right angles to the axis of revolution X, between said axis of revolution X and the centre F of the foot 542 of the base reinforcement 54, taken on a central axis F thereof.

Thus, the suction element 64 of the offloading device 6 is distinct from the masts 52 of the column 5. The offloading device 6 is situated outside of the triangular form delimited by each of the masts 52.

According to the invention, at least one holding device 9 extends between the offloading duct 61 and one of the masts 52 of the structure 51. The holding device 9 makes it possible to hold the offloading duct 61 in the vertical direction V and ensures that it is held notably when loading the tank 2 or even when transporting liquefied gas. According to the example of the invention, a plurality of holding devices 9 extends between one of the masts 52 of the structure 51 and the offloading duct 61, along the latter, that is to say between its first end 61a and the cover 7. According to the example illustrated, the at least one holding device 9 extends between the offloading duct 61 and the front mast 52a of the structure 51, that is to say the mast 52 forming the front vertex of the triangle delimiting the structure 51.

The holding device 9 thus makes it possible to form the link between the offloading device 6 and the column 5, both distinct from the bottom wall 22 of the tank. Thus, the holding device 9 is located away from the bottom wall 22 of the tank.

Such holding devices 9 can be produced according to different embodiments, explained hereinbelow, and can be formed at different locations on the column 5.

Preferably and as represented in FIG. 2, the holding devices 9 according to the invention are fixed onto the front mast 52a at fixing points fixing the lattice structure 53 onto the front mast 52a. More particularly, the holding devices 9 are fixed at points of intersection of several cylindrical small beams forming the lattice structure 53 on the front mast 52a. Thus, the holding devices 9 are positioned at points where the rigidity of the column 5 is maximal.

In addition, a holding device 9 can also be positioned at a bottom end of the front mast 52a where the platform 541 of the base reinforcement 54 is also fixed.

The holding device 9 comprises at least one ring 91, through which passes the offloading duct 61 of the offloading device 6, and at least one arm 92 equipped with a fixing interface 923 for fixing the holding device 9 onto the front mast 52a.

From this point, the first embodiment of the holding device 9 visible in FIGS. 5 and 6 will be described.

The ring 91 is composed of two half-shells 911, called first half-shell 9111 and second half-shell 9112, of substantially identical form. When they are assembled, the half-shells 911 form the ring 91, which is cylindrical, intended to encircle the offloading duct 61. Alternatively, the ring 91 can comprise more than two portions of complementary forms, assembled to form the ring 91. According to another alternative, the ring 91 can comprise a single cylindrical piece.

Each of the half-shells 911 comprises two fins 912, the fins 912 of one of the half-shells 911 being placed in contact and then secured, here by bolting, with the fins 912 of the complementary half-shell 911 in order to assemble the ring 91. Notably, in the example illustrated, the ring 91 is centred on an axis of extension 900 of the holding device 9 extending in the vertical direction V.

Furthermore, a shim 916 is positioned between two fins 912 disposed facing one another and intended to be fixed to one another. The aim of this shim 916 is more particularly to ensure the holding of the rod or rods 611 on the offloading duct 61. Each rod 611 is retained in the ring 91. Preferably, each rod 611 extends between two assembled fins 912. Thus, in the assembled position, each rod 611 extends between a shim 916 and the offloading duct 61.

An inner wall 913 of the ring 91 is equipped with a plurality of skids 914 allowing the displacement of the offloading duct 61 along the axis of extension 900, which is observed in particular as a result of the thermal expansion of the offloading duct 61. The skids 914 can be produced in a material such as PTFE (for polytetrafluoroethylene) or HDPE (for “high density polyethylene”) and extend parallel to the axis of extension 900, over a height of the ring 91 measured along this same axis. Alternatively, the skids 914 can extend only over a part of the height of the ring 91.

The arm 92 of the holding device 9 comprises a first segment 921, a second segment 922 and a fixing interface 923. The first segment 921 and the second segment 922 each have the form of a flat plate. For example, each segment 921, 922 can consist of a piece of sheet metal at least 5 mm thick. The first segment 921 and the second segment 922 are initially separated from one another, the securing thereof being performed when they are mounted on the column 5.

Preferably, the second segment 922 has a length greater than the diameter of the ring 91.

The first segment 921 is secured to one of the half-shells 911 of the ring 91. The first segment 921 comprises a cutout 9211 of a form complementing an outer wall 915 of the half-shell 911, in order for the first segment 921 to be in contact with the outer wall 915 of the ring 91 and encircle, at least partially, the half-shell 911 which is attached to it. Thus, once the holding device 9 is assembled, the first segment 921 bears the ring 91.

Likewise, the second segment 922 bears the fixing interface 923, the latter extending transversely, for example at right angles, to a plane in which said second segment 922 is mainly inscribed.

When the holding device 9 is assembled, the first segment 921 and the second segment 922 extend partly facing one another. As illustrated, the first segment 921 and the second segment 922 extend parallel to a first plane 100 of the holding device 9 which is orthogonal to the axis of extension 900 of the holding device 9 and/or to the main axis 500 of at least one of the masts 52 of the column 5.

The first segment 921 and the second segment 922 each have assembly means 94 allowing these two elements to be secured to one another in order to constitute the arm 92.

The first segment 921 and the second segment 922 are particularly configured to be displaced with respect to one another in a first direction 200 and a second direction 300, included in the first plane 100. Preferably, the first direction 200 and the second direction 300 are at right angles to one another.

The assembly means 94 comprise a first pair of oblong holes 941 produced in the first segment 921, just one of these oblong holes is visible in FIGS. 5 and 6, each oblong hole is configured to receive at least one fixing member 945. The oblong holes 941 extend parallel to one another, a longest dimension of each of the oblong holes 941 extending parallel to the first direction 200 and at right angles to the axis of extension 900 of the holding device. Each oblong hole 941 extends preferably at a lateral end of the first segment 921.

The assembly means 94 also comprise at least one second pair of oblong holes 942 produced in the second segment 922, for example two second pairs of oblong holes 942. Each oblong hole 942 of the second segment 922 extends at least partly opposite one of the oblong holes 941 of the first segment 921 when the holding device 9 is assembled. In particular, a longest dimension of an oblong hole 942 of the second segment 922 extends parallel to the second direction 300, and therefore substantially at right angles to the first direction 200 of at least one of the oblong holes 941 of the first segment 921.

The oblong holes 941, 942 of the first segment 921 and second segment 922 also constitute adjustment means 943 allowing an adjustment of the mutual positioning of the different segments 921, 922. Thus, according to the position of the fixing member in the oblong holes respectively of the first segment 921 and second segment 922, the position of the different segments 921, 922 will be able to vary.

The fixing members 945 used to secure the first segment 921 and the second segment 922 can be composed of screw-nut systems or any other appropriate means, the fixing members 945 having to be designed so as to provide a mutual displacement of the segments 921, 922 during the mounting of the offloading device 6 or during a subsequent dismounting.

A face of the first segment 921 is thus secured with a face of the second segment 922. The first segment 921 comprises a first face 9212, turned towards the cover 7 of the column 5, and a second face 9213, turned towards the bottom wall 22 of the tank, while the second segment 922 comprises a first face 9221, turned towards the cover 7, and a second face 9222, opposite, turned towards the bottom wall 22 of the tank. Notably, in the holding device 9 as illustrated, the second face 9213 of the first segment 921 is secured to the first face 9221 of the second segment 922. Thus, the first segment 921, bearing the ring 91 and therefore the offloading duct 61, is borne by the second segment 922.

The fixing interface 923 allows the holding device 9 to be secured onto the column 5. Preferably, the fixing interface 923 is fixed onto the front mast 52a of the column. Such an interface can, as illustrated, allow the offloading duct 61 to be held on the column 5 at different points according to the height thereof, the offloading duct 61 extending so as to pass through the ring 91.

The fixing interface 923 takes the form of a shell with a section in the form of a circular arc. The fixing interface 923 is borne by the second segment 922 and is intended to be fixed onto the column 5, for example by welding.

Very clearly, other forms of fixing interface can be envisaged.

The holding device 9 comprises a plurality of reinforcements 93 respectively consolidating the link of the first segment 921 with the half-shell 911 to which the first segment 921 is attached, and the link of the second segment 922 with the fixing interface 923. Thus, the reinforcements 93 extend between the first face 9212 of the first segment 921 and the outer wall 915 of the ring 91 or between the first face 9221 of the second segment 922 and a first flank 9231 of the fixing interface 923. Also, the reinforcements 93 can extend between the second face 9222 of the second segment 922 and the first flank 9231 of the fixing interface 923.

In the example represented, there is no reinforcement between the second face 9213 of the first segment 921 and the outer wall 915 of the ring 91 in order not to hamper the assembly of the different elements with one another. However, according to a variant embodiment, the presence of such reinforcements can be envisaged notably in the case of a redimensioning of these different elements.

The second segment 922, secured to the fixing interface 923, comprises a second cutout 9223. The second cutout 9223 is particularly configured in order to facilitate the mounting/dismounting of the holding device 9, for example by allowing a flange retaining the offloading duct 61 to pass through. Preferably, the second cutout 9223 has a greater indentation than the cutout 9211 of the first segment 921 and, when the holding device is assembled, the first segment 921 covers, at least partially, the second cutout 9223.

The holding device 9 according to the invention ensures that the offloading device 6 is held well in the tank and provides the latter with the necessary mechanical strength, notably with respect to the sloshings that are likely to be generated by the cargo of liquefied gas in the tank. The use of the holding device contributes to limiting the movement of the suction element 64, but also the risks of distortion thereof.

The second embodiment of the holding device 9, visible in FIGS. 7 and 8, will, from this point, be described. The elements that are common with the first embodiment will use the same references and will not be described again.

Thus, the holding device 9 according to the second embodiment comprises, like the first embodiment, an arm 92 comprising a first segment 924, bearing the ring 91 through which the offloading duct 61 of the offloading device 6 passes, and a second segment 925 bearing the fixing interface 923. This holding device 9 also comprises a link assembly 926 intended to ensure the fixing of the first segment 924 and of the second segment 925 to one another, as will be described hereinbelow. The link assembly 926 is more particularly composed of two plates 9261 and 9262, each intended to be interposed between fixing zones of the first segment 924 and of the second segment 925 disposed facing one another.

Preferably, the second segment 925 has a length less than the diameter of the ring 91.

The plates 9261, 9262 of the link assembly 926 are preferably of identical form. Each plate 9261, 9262 comprises an oblong form and is provided with an orifice 9263. In the example represented, each plate 9261, 9262 comprises three orifices 9263 of circular form.

The first segment 924 comprises two wings 9241 and 9242 extending away from one another and spaced apart in a first direction 600 extending at right angles to the axis of extension 900 of the holding device and/or to the main axis 500 of at least one of the masts 52 of the column 5.

Preferably, the two wings 9241, 9242 extend parallel to one another and each extend in a plane parallel to a first plane 400 which is parallel to the axis of extension 900 of the holding device 9 and/or to the main axis 500 of at least one of the masts 52 of the column 5. Each wing 9241, 9242 comprises an inner face 9243 and an outer face 9244. The inner faces 9243 face one another and are situated opposite one another, while the outer faces 9244 are opposite the inner faces and are turned towards the walls of the tank.

Likewise, the second segment 925 comprises two wings 9251 and 9252 extending away from one another and spaced apart in the first direction 600 extending at right angles to the axis of extension 900 of the holding device and/or to the main axis 500 of at least one of the masts 52 of the column 5.

Preferably, the two wings 9251, 9252 extend parallel to one another and each extend in a plane parallel to the first plane 400 which is parallel to the axis of extension 900 of the holding device 9 and/or to the main axis 500 of at least one of the masts 52 of the column 5. Each wing 9251, 9252 comprises an inner face 9253 and an outer face 9254. The inner faces 9253 face one another and are situated opposite one another, while the outer faces 9254 are opposite the inner faces and are turned towards the walls of the tank.

As in the first embodiment, the holding device 9 comprises a plurality of reinforcements 93 respectively consolidating the link of the first segment 924 with the half-shell 911 to which the first segment 924 is attached, and the link of the second segment 925 with the fixing interface 923. Thus, the reinforcements 93 extend between each outer face 9244 of each wing 9241, 9242 of the first segment 924 and the outer wall 915 of the ring 91. As represented, the reinforcements 93 can also extend between each outer face 9254 of each wing 9251, 9252 of the second segment 925 and the first flank 9231 of the fixing interface 923.

In such an embodiment, the reinforcements 93 extend in a plane which is orthogonal to the first plane 400.

The second segment 925 also comprises at least one internal reinforcement 95 intended to link, substantially in their middle, each inner face 9253 of each wing 9251, 9252.

In the example represented, the separation between the wings 9251, 9252 of the second segment 925 is less than the separation between the wings 9241, 9242 of the first segment 924, so as to allow, during the assembly of the arm 92, the securing of each wing of the first segment with a wing of the second segment situated opposite. More particularly, the separation is adapted so as to allow the insertion of each plate 9261, 9262 of the link assembly 926 as will be described hereinbelow.

The first segment 924, the second segment 925 and the link assembly 926 each have assembly means 94 allowing these three elements to be secured in order to constitute the arm 92.

The assembly means 94 of the link assembly 926 consist of the orifices 9263 of the plates 9261, 9262.

The assembly means 94 also comprise circular holes 9245 produced in each wing 9241, 9242 of the first segment 924. The circular holes 9245 are regularly distributed on each free end of the wings 9241, 9242, the so-called free end being that opposite the end fixed to the ring 91. There can, for example, be three circular holes 9245 per wing 9241, 9242.

The assembly means 94 also comprise oblong holes 9255 produced in each wing 9251, 9252 of the second segment 925. The oblong holes 9255 are regularly distributed on each free end of the wings 9251, 9252, the so-called free end being that opposite the end fixed to the fixing interface 923. There can, for example, be three oblong holes 9255 per wing 9251, 9252.

The oblong holes 9255 extend parallel to one another, a longest dimension of each of the oblong holes 9255 extending at right angles to the first direction 600 and at right angles to the axis of extension 900 of the holding device.

The assembly means 94 further comprise fixing members 945, such as screw-nut assemblies intended to link the circular holes of the link assembly 926 and of the first segment 924, with the oblong holes of the second segment 925.

Thus, in the assembled position of the arm 92, the outer face 9254 of each wing 9251, 9252 of the second segment 925 is disposed facing the inner face 9243 of a wing 9241, 9242 of the first segment 924. A plate 9261, 9262 is interposed between the outer face 9254 and the inner face 9243. These different pieces are positioned such that their respective orifices are located facing one another so as to be able to be passed through by the fixing members 945.

The different holes or orifices of the first and second segments 924, 925 and of the link assembly 926 also constitute the adjustment means 943 allowing an adjustment of the mutual positioning of the different segments 924, 925. Thus, according to the position of the fixing member in the holes or orifices, the position of the different segments 924, 925 will be able to vary.

According to a variant that is not represented, the separation between the wings 9251, 9252 of the second segment 925 can be greater than the separation between the wings 9241, 9242 of the first segment 924. Likewise, the positioning of the oblong holes and of the circular orifices can vary.

From this point, the different steps of mounting of the holding device 9 performed according to the second embodiment and intended to secure the front mast 52a and the offloading duct 61 of the offloading device 6 disposed in proximity will be described in relation to FIGS. 9a to 9d. In order to facilitate understanding, the link assembly 926 is not represented in these figures.

During a prior step that is not represented, the subassembly 96 consisting of the fixing interface 923 and the second segment 925, hereinafter called first subassembly, is secured to the front mast 52a, preferably by welding.

During the first step represented in FIG. 9a, the subassembly 97 consisting of the first segment 924 and the second half-shell 9112, hereinafter called second subassembly, is fixed to the first subassembly 96. During this first step, the first segment 924, the second segment 925 and the link assembly 926 are secured via the fixing members 945 so as to define a first position. In this first position, the first subassembly 96 and the second subassembly 97 are brought towards one another as shown by the arrow 98, so that their overlap is maximal. In this position, the second subassembly 97 is located closest to the mast 52a.

During the second step represented in FIG. 9b, the offloading duct 61 of the offloading device 6 is brought closer to the second subassembly 97. Thus, the offloading duct 61 is lowered along the mast 52a and runs alongside the second subassembly 97, while remaining at a distance therefrom. The position of the offloading duct 61 is defined by the different elements constituting the offloading device 6 and more particularly by the suction element 64 and the drive assembly 62, the latter having to be aligned with the offloading duct 61 in order to avoid any twisting of the offloading device 6. During the mounting of the offloading device 6, the suction element 64 is centred on the axis of revolution X of the sump wall 81. As FIG. 9b shows, at the end of the second step, the offloading duct 61 is located away from the inner wall 913 of the second half-shell 9112.

Once the final position of the offloading duct 61 has been reached, the second subassembly 97 is displaced with respect to the first subassembly 96. More particularly, the second subassembly 97 is displaced so as to allow the docking of the second subassembly 97, and more particularly of the inner wall 913 of the second half-shell 9112, with the offloading duct 61. This displacement, illustrated by the arrow 99, corresponds to the third mounting step represented in FIG. 9c.

The positioning between the first subassembly 96 and the second subassembly 97 is performed using the adjustment means 943 which allow a displacement of the first segment 924 and second segment 925 in the first plane 400, and more specifically a displacement in two directions lying in this same first plane 400. The fixing members 945 can then be repositioned so as to fix the new position of the first subassembly 96 and of the second subassembly 97.

Once the appropriate position has been obtained, during a final step represented in FIG. 9d, the first half-shell 9111 is brought closer and fixed to the second half-shell 9112 through the securing of their fins 912.

All of these steps are repeated as many times as necessary depending on the number of holding devices 9 to be positioned along the column 5.

The use of the holding device 9 according to the invention offers the advantage also of simplifying the disassembly of the column 5 during maintenance operations entailing the extraction of an element. Indeed, the second segment 925 and the fixing interface 923 can remain secured to the column 5, while the first segment 924 is dissociated from the second segment 925. Access to the offloading device 6 is thus facilitated. Thus, in the case of a maintenance operation, there is no need to entirely remove the holding device 9 according to the invention to allow the extraction of the offloading device 6 or of one of its components. This also results in simplifying reassembly of all of these elements since there is no need to reposition and fix the fixing interface 923 and the second segment 925.

The mounting method explained herein in relation to the second embodiment applies of course to the first embodiment.

The invention cannot however be limited to the means and configurations described and illustrated here, and it extends also to any equivalent means or configuration and to any technical combination operating such means. In particular, the type of fixing interface, the dimensions or form of the arms, and the assembly means used to secure the different segments of the arm will be able to be modified without detriment to the invention, in as much as the adjustment device, ultimately, fulfils the same functionalities as those described in this document.

In addition, the holding device described can also be applied to any other fixing purpose for components intended to cooperate with one of the elements of the column 5.

With reference to FIG. 10, a cutaway view of a methane tanker ship 1 shows a sealed and insulated tank 2 of generally prismatic form mounted in the double-hull 11 of the ship.

As is known per se, loading/offloading pipelines 12 disposed on the top deck of the ship can be connected, by means of appropriate connectors, to a maritime or port terminal to transfer a cargo of LNG from or to the tank 2.

FIG. 10 also represents an example of maritime terminal comprising a loading and offloading station 13, a submarine duct 14 and an onshore installation 15. The loading and offloading station 13 is a fixed offshore installation comprising a movable arm 16 and a riser 17 which supports the movable arm 16. The movable arm 16 bears a bundle of insulated flexible pipes 18 that can be connected to the loading/offloading pipelines 12. The orientable movable arm 16 adapts to all methane tanker templates. A link duct that is not represented extends inside the riser 17. The loading and offloading station 13 allows the methane tanker 1 to be loaded and offloaded from or to the onshore installation 15. The latter comprises liquefied gas storage tanks 19 and link ducts 24 linked by the submarine duct 14 to the loading or offloading station 13. The submarine duct 14 allows liquefied gas to be transferred between the loading or offloading station 13 and the onshore installation 15 over a great distance, for example 5 km, which makes it possible to keep the methane tanker ship 1 at a great distance from the coast during the loading and offloading operations.

To generate the pressure necessary for the transfer of the liquefied gas, pumps embedded in the ship 2 and/or pumps with which the onshore installation 15 is equipped and/or pumps with which the loading and offloading station 13 is equipped are implemented.

Although the invention has been described in relation to several particular embodiments, it is quite clear that it is in no way limited thereto and that it encompasses all the technical equivalents of the means described and the combinations thereof if the latter fall within the context of the invention, as defined by the claims.

The use of the verb “comprise” or “include” and its conjugated forms does not preclude the presence of elements or steps other than those stated in a claim.

In the claims, any reference symbol between parentheses should not be interpreted as a limitation of the claim.

1. A loading and/or offloading assembly for a tank of a ship configured to contain a liquefied gas comprising:
a loading and/or offloading column provided with at least one mast configured to extend in the tank;
at least one offloading device distinct from the loading and/or offloading column; and
at least one holding device holding at least a part of the offloading device on the loading and/or offloading column, the holding device being for holding at least a part of the offloading device on the mast,
the holding device comprising at least one ring, through which passes at least a part of the offloading device, and at least one arm, the arm comprising at least one first segment bearing the ring and one second segment bearing a fixing interface for fixing the holding device onto the loading and/or offloading column, the first segment and the second segment being configured to be displaced with respect to one another in at least two directions lying in a same plane .

2. The loading and/or offloading assembly according to claim 1, wherein said plane is parallel to the first segment and/or to the second segment of the arm.

3. The loading and/or offloading assembly according to claim 1, wherein the ring is centred on an axis of extension of the holding device and wherein the axis of extension extends parallel to said plane .

4. The loading and/or offloading assembly according to claim 1, wherein the ring is centred on an axis of extension of the holding device and wherein the axis of extension extends orthogonally to said plane, and wherein the axis of extension extends at right angles to said plane.

5. The loading and/or offloading assembly according to claim 1, wherein the ring (91) is composed of at least one first half-shell and one second half-shell, the first half-shell and/or the second half-shell being borne by the first segment.

6. The loading and/or offloading assembly according to claim 1, wherein the holding device comprises at least one reinforcement secured to the first segment and to the ring and/or to the second segment and to the fixing interface.

7. The loading and/or offloading assembly according to claim 1, wherein the first segment and the second segment each respectively comprise two wings extending away from one another, the separation between the wings of the first segment being different from the separation between the wings of the second segment, so as to allow an overlap between each wing of the first segment with a wing of the second segment situated facing it.

8. The loading and/or offloading assembly according to claim 7, wherein the separation between the wings of the first segment is greater than the separation between the wings to the second segment.

9. The loading and/or offloading assembly according to claim 7, wherein the wings of the first and second segments each comprise inner faces disposed in such a way that an inner face of one wing of a segment is disposed facing an inner face of the other wing of said segment, and outer faces opposite said inner faces, each inner face of a wing of the first segment being disposed facing an outer face of a wing of the second segment.

10. The loading and/or offloading assembly according to claim 9, wherein at least one link assembly is disposed between the inner face of a wing of one segment and the outer face of a wing of the other segment disposed facing it.

11. The loading and/or offloading assembly according to claim 1, wherein the first segment and the second segment are secured to one another by assembly means, said assembly means being removable.

12. The loading and/or offloading assembly according to claim 11, wherein the assembly means comprise at least one fixing member for fixing the first segment onto the second segment, the first segment and/or the second segment comprising at least one oblong hole which receives the fixing member.

13. The loading and/or offloading assemblyaccording to claim 12, wherein the first segment and the second segment each comprise at least one oblong hole at least partly disposed facing one another, the oblong hole of a segment extending mostly in a direction at right angles to a major direction of extension of the oblong hole of the other segment.

14. The loading and/or offloading assemblyaccording to claim 1, wherein the offloading devicecomprises at least one suction element, disposed in the tank, and a drive assembly driving the suction element, disposed outside of the tank, the suction elementand the drive assemblybeing linked to one another by an offloading duct, the ringof the holding deviceat least partly encircling the offloading duct.

15. A tankof a ship configured to contain a liquefied gas, the tank comprising a loading and/or offloading assembly according to claim 1 .

16. A method for mounting a loading and/or offloading assembly for a tank of a ship configured to contain a liquefied gas according to claim 5, the method comprising:
fixing of the second segment onto the loading and/or offloading column via the fixing interface by:
fixing of the first segment and of the second half-shell borne by the first segment onto the second segment in a first, so-called adjustment position in which the first segment is positioned as close as possible to the loading and/or offloading column;
final positioning of at least one element of the offloading device in the tank;
displacement of the first segment and of the second half-shell to a second, so-called final position in which the second half-shell is positioned as close as possible to the element of the offloading device (6);
assembly and of fixing of the first half-shell onto the second half-shell so as to encircle said element of the offloading device between the first half-shell and the second half-shell .

17. The method for mounting an offloading device according to claim 16, wherein said element of the offloading deviceis an offloading duct.

18. A shipfor transporting a cold liquid product, the ship comprising: a double-hull; and a tank according to claim 15 disposed in the double-hull.

19. A transfer system for a cold liquid product, the system comprising: a ship according to claim 18; insulated pipelines arranged so as to link the tank installed in the double-hull of the ship to a floating or onshore storage installation; and a pump for driving the fluid through the insulated pipelines from or to the floating or onshore storage installation to or from the tank of the ship.

20. A method for loading or offloading a ship according to claim 18, comprising: conveying a fluid through insulated pipelines from or to a floating or onshore storage installation to or from the tank of the ship.
